(19) United States
(12) Patent Application Publication
(10) Pub. No.: US 2008/0071694 A1
(43) Pub. Date: Mar. 20, 2008

(54) VIRTUAL FINANCIAL MARKET

(76) Inventors: Torkel Blomgren, Stockholm (SE); Hakan Ostberg, Umea (SE); Jan Johansson, Umea (SE); Bo Sehlstedt, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/465,229

(22) Filed: Aug. 17, 2006

(51) Int. Cl. G06Q 40/00

(52) U.S. Cl. 705/36 R

(57) ABSTRACT

The method and a system are for adapting the original Black-Scholes option pricing model to determine real time calculated theoretical odds for scenarios of the pricing of financial instruments to create a virtual financial market. End users are able to make earnings relating to calculated odds for a price of the instruments at a predetermined discrete time creating an odds model which automatically calculates price during the trading hours of an actual financial market. The odds are reflecting the expectations of the actual financial market. The invention also includes the introduction of an implied risk premium in the Black-Scholes model for option pricing.

### TECHNICAL FIELD

The present invention pertains to a method and a system of adapting the original Black-Scholes option pricing model to determine real time calculated theoretical odds for scenarios of the pricing of financial instruments. Hereby creating a virtual financial market where end users are able to make earnings relating to the calculated odds for a price of the instruments at a predetermined discrete time. Hence, creating an odds model which automatically calculates price during the trading hours of an actual financial market. The odds reflecting the expectations of the actual financial market.

### BACKGROUND OF THE INVENTION

The financial market has a complex structure hard to grasp if not an expert. Thus there is a need for methods and systems educating layman, which rely on real financial market parameters in real time. Furthermore, it would be favorable if those utilizing such a system could earn money on betting in such a financial system.

The patent application EP1139245 to Sireau describes a fixed-odds betting system, which comprises a user terminal operable to accept parameters, input by a user, relating to a fixed-odds bet on an aspect of a financial market. Moreover it comprises a central processing machine, which has a data feed to a source of data concerning a financial market. There are also means operable to calculate the fixed odds for the bet, based on at least some of the parameters input by the user and the data obtained from the data feed. Hence, this application teaches that a user has to provide parameters inherent in the betting game per se to calculate the odds, and not how to calculate odds in real time.

Published patent application document US20030195841 to Ginsberg et al presents systems and methods for real-time interactive wagering on event outcomes. Clients are first qualified and given wagering limits before they are allowed to interactively wager on event outcomes.

Event outcomes may be based on, for example, financial markets and indices, sporting and entertainment events, casino performances, and natural phenomena such as weather and earthquakes. Events on which wagers can be placed include both those with known and unknown outcome probabilities, and wagers can be a fixed-odds type or a spread-bet type. Wager transactions, including acceptances and confirmations, are executed in real time. Clients can customize displays of events on which they are authorized to wager. Real-time client credit management, automatic dealer hedging, automatic price-spread adjustments, and automatic client and dealer defined wagering limits are also provided. This application does not utilize real time financial market pricings to calculate odds for betting.

### SUMMARY OF THE INVENTION

The present invention relates to a method and a system making up a virtual financial market based on for instance real stock/commodity markets pricings of entities of financial instruments through real time calculated theoretical odds for scenarios of the pricing of financial instruments. It is appreciated that the present invention can be utilized not only to the stock or commodity market, but also to other known entities of financial instruments. The stock/commodity market is only utilized to give an apprehensive example to the embodiments of the present invention.

Hence, the present invention sets forth a method of adapting the original Black-Scholes option pricing model to determine real time calculated theoretical odds for scenarios of the pricing of financial instruments. Thus creating a virtual financial market where end users are able to make earnings relating to the calculated odds for a price of the instruments at a predetermined discrete time. Hereby an odds model is created which automatically calculates price during the trading hours of an actual financial market. The odds reflect the expectations of the actual financial market, whereby the method has the steps of:

utilizing the Black-Scholes option pricing adapted to comprise the number of trading days until the predetermined discrete time including fractions of a day, divided by actual trading days of a trading year, taking into account an implied risk premium provided in the Black-Scholes option pricing model; and

paying the end users the amount betted on the financial instruments at a correct betting, times at least a fraction of the calculated odds, thus creating a virtual financial market.

One embodiment of the present invention comprises that the calculated odds is subtracted by a margin to form the fraction of the calculated odds.

Another embodiment comprises that the virtual financial market is utilized to educate end users of the trade rules and price fluctuations of pricings of the instruments in a financial market.

A further embodiment comprises that the implied risk premium provided in the Black-Scholes option pricing model is comprised in the modal where conventionally a continuous yield is situated, but with reversed plus and minus signs, respectively.

Moreover, the present invention sets forth a system adapted to the trade of bets on financial instruments on a financial market, thus opening up a virtual market to make earnings related to the actual financial market pricings for the financial instruments. The system has:

a generator software in a server in a network for at least one of data and telecommunication, adapted to generate real time odds for scenarios of the pricing of financial instruments for a plurality of entities belonging to the instruments, every entities odds being calculated theoretically from a real time pricing of an entity on the actual financial market, and subtracted by a predetermined margin based on a percentage constituting a final calculated odds, the margin is set by at least one administrator running the system, the real time odds being based on financial market expectations according to a modified Black-Scholes option theory utilized for a financial market, the modified Black-Scholes model taking into account an implied risk premium provided in the Black-Scholes option pricing model; and

an interface in the network connecting end users to stake according to the final calculated odds to a determined pricing based on the modified Black-Scholes theory for at least one of the entities, the final odds being valid a predetermined discrete time for the pricing, whereby the end customer is paid the stake times the final calculated odds if the pricing is valid within a predetermined range of pricing at the lapse of the discrete time, the end user thus being provided to make bets based on a real financial market through the virtual financial market.

Furthermore, the method and system of the present invention comprises further embodiments in accordance with the embodiments of the above described method.

### BRIEF DESCRIPTION OF THE DRAWINGS

Henceforth reference is had to the attached figures in the accompanying text of the description for a better understanding of the present invention with its embodiments and given examples, wherein:

FIG. 1 illustrates one embodiment of an interface utilized by an end user to trade betting products in accordance with the present invention;

FIG. 2 illustrates a further function in the interface of FIG. 1 in accordance with the present invention;

FIG. 3 schematically illustrates one embodiment of a system for trading in accordance with the present invention; and

FIG. 4 illustrates a more detailed embodiment of a system for trading in accordance with the present invention.

### DETAILED DESCRIPTION OF PREFERRED EMBODIMENTS

An aspect of the present invention is to provide odds, for scenarios of the pricing of financial instruments, based on a virtual financial market relating on for instance, but not limited to those given as an example, that a share/index on an existing real stock/commodity market closes above (high/above level pricing betting) a certain level of pricing on the day/time of closure decided by administrator running/administrating the virtual stock/commodity market, that the share/index closes below (low/below level pricing betting) a certain level on the day/time of closure, or that it closes within a predetermined interval (interval betting). Out of these basic forms of betting it is possible to derive multiple variants of betting for end users.

Another aspect of the present invention comprises to automatically, through software, set/settle odds for scenarios of the pricing of financial instruments on course rating movements during the trading hours of an existing ordinary stock/commodity market. These odds are called market odds, i.e., they should reflect the expectations of the existing stock/commodity market.

In order to exemplify how theoretical betting odds are calculated to be utilized by a betting company and an end user, for example, customer betting by a PC program via a network such as Internet, the following classic example is provided. Betting consists of an end user being offered odds for heads and tails, respectively. The probability for the events heads and tails should normally be equal, 50% each. A theoretical odds for each event is thus calculated as 1/0.50=2.0. The betting company, in order to make earnings, has to apply a margin, thus offering the end user odds lower than the theoretical odds, for example, 1.8 times the betted money (10% margin). At an even betting distribution, the betting company will earn 10% of the entire number of betting stakes.

A more complicated equation to calculate odds is utilized to provide odds for scenarios of the pricing of financial instruments in accordance with the present invention, which presents an adapted/modified Black-Scholes option pricing model. The original Black-Scholes option pricing model is provided through, including some what different variables than the present invention model:

### The Model:

C=SN(d₁)−Ke^{(-rt)}N(d₂)
C=Theoretical call premium
S=Current Stock price
t=time until option expiration
K=option striking price
r=risk-free interest rate
N=Cumulative standard normal distribution
e=exponential term (2.7183)

$${d}_{1} = \frac{ln ( S / K ) + ( r + {s}^{2} / 2 ) t}{s \sqrt{t}}$$

d₂=d₁−s\sqrt{t}
s=standard deviation of stock returns
ln=natural logarithm

A theoretical odds (odds_{theoretical}) is calculated, Black-Scholes, through an odds function C according to the latter. Input to this function according to the present invention is constituted of the following variables making up the adapted/modified Black-Scholes model; S₀: actual betting rate in real time, a mathematical approximation of the current price of the betting object, r: continuous free of risk interest (betting interest) in real time, X: betting target level provided by a database for betting objects, the number of calendar days (also a fraction of a day) to the closure day for a betting derived out off the current day and the betting object attributes closure day, the number of calendar days of a year (constant), the number of trading days (also a fraction of a day) until the closure day for the betting derived out off the current day and the betting object attributes closure day (input of trading free days can be provided manually in the administration tool utilized by an administrator of the virtual stock/commodity market), The number of trading days a year (constant), σ: volatility for the type of betting, the underlying rating course and the closure day are provided by the database for betting objects, D: share/index dividend and the number of days to the payment of share/index dividends, T_{D}, (also a fraction of a day) are provided from manually stored data, m: odds margin. Hence it provides the following modified Black-Scholes model/function in accordance with the present invention:

$$odds \begin{matrix}Hi \\ Cl\end{matrix} = {N ( \frac{ln ( \frac{{S}_{0} - D {e}^{- {T}_{D} r}}{X} ) + ( r + \frac{{σ}^{2} {τ}_{1}}{2 {τ}_{2}} ) {τ}_{2} - \frac{{σ}^{2} {τ}_{1}}{2}}{σ \sqrt{{τ}_{1}}} )}^{- 1} \cdot ( 1 - m ) \qquad ( 1 )$$

### _{Cl}^{Hi} indicates high level pricing betting.

$$\begin{matrix}{τ}_{1} = \frac{Number of trading days to closure}{Number of trading days a year} , & ( 2 ) \\ {τ}_{2} = \frac{Number of calendar days to closure}{Number of calendar days a year} & ( 3 )\end{matrix}$$

The basic of the present invention option pricing model/function is the Black-Scholes adapted/modified to differences in the number of trading days/real days, discrete and continuous dividend:

$$\begin{matrix}c = ( {S}_{0} - D {e}^{- {T}_{D} r} ) {e}^{- {qτ}_{2}} N ( {d}_{1} ) - X {e}^{- {rτ}_{2}} N ( {d}_{2} ) & ( 4 ) \\ {d}_{1} = \frac{ln ( \frac{{S}_{0} - D {e}^{- {T}_{D} r}}{X} ) + ( r - q ) {τ}_{2} + \frac{{σ}^{2} {τ}_{1}}{2}}{σ \sqrt{{τ}_{1}}} & ( 5 ) \\ {d}_{1} = \frac{ln ( \frac{{S}_{0} - D {e}^{- {T}_{D} r}}{X} ) + ( r - q ) {τ}_{2} - \frac{{σ}^{2} {τ}_{1}}{2}}{σ \sqrt{{τ}_{1}}} & ( 6 )\end{matrix}$$

The expression N(d₂) provides the probability that S_{T}≧X on the closure day in a risk neutral world. This probability is not observable on the market. To catch the real probability, the risk neutral world has to be abandoned.

When leaving the risk neutral world for the real world, the expected value for the revenue for a share changes, but its volatility does not change. The catch is to find the “real” drift which except for a component without risk also comprises taking into account an implied risk premium provided in the Black-Scholes option pricing model in accordance with the present invention, which the market demands in exchange for its taking of risks.

A basic approach to find the real probability that S_{T}≧X at the closure date is a stochastic process without a drift, a margin, having the feature that its expected value at an arbitrary discrete time in the future equals the current known value:

dθ=σdz

E[θ_{T}]=θ₀ (7)

This together with the believe in an efficient market provides that the probability for a share value to rise/ascend should be equal to the probability of a share value to fall/descend, irrespective of the time horizon, provided that the interest rate free of risk is zero.

As an implied risk premium provided in the Black-Scholes option pricing model is regarded as a negative continuous dividend in Black-Scholes, the opportunity to find the “implied risk premium” which the market looks for is to find the value q in Black-Scholes that provides that N(d₂)=N(−d₂)=50% when r=0, S₀=X and τ₁,τ₁>0.

Analytical it is given:

$$N ( {d}_{2} ) = N ( - {d}_{2} ) = 0 , 5 ⇔ \\ {d}_{2} = 0 = \frac{ln ( \frac{{S}_{0} - D {e}^{- {T}_{D} r}}{X} ) + ( r - q ) {τ}_{2} - \frac{{σ}^{2} {τ}_{1}}{2}}{σ \sqrt{{τ}_{1}}} ⇔ \\ ⇔ \{ \begin{matrix}{S}_{0} - D {e}^{- {T}_{D} r} = X \\ r = 0 \\ {τ}_{1} , {τ}_{2} > 0\end{matrix} \} ⇔ … \\ 0 = \frac{ln ( 1 ) - q {τ}_{2} - \frac{{σ}^{2} {τ}_{1}}{2}}{σ \sqrt{{τ}_{1}}} ⇒ , \\ q = - \frac{{σ}^{2} {τ}_{1}}{2 {τ}_{2}} \qquad ( 8 )$$

i.e., with a q according to (8) provided as a continuous (negative) yield in Black-Scholes d₂, eqv (6), N(d₂) states the real probability that a share ends higher than/above a certain price, X, at the day of closure. The odds thus being N (d₂)⁻¹·(1−m) where m is the margin of a bet. A similar approach is applied to calculate the odds of a share to end lower than/below a certain price X at the day of closure, in this case 1−N(d₂) is used instead of N(d₂), or to calculate the odds of a share to end in an certain interval, X1−X2, where X1>X2, at the day of closure, in this case the total probability is calculated by subtracting the probability for the share to end higher than/above X1 from the probability for the share to end higher than/above X2.

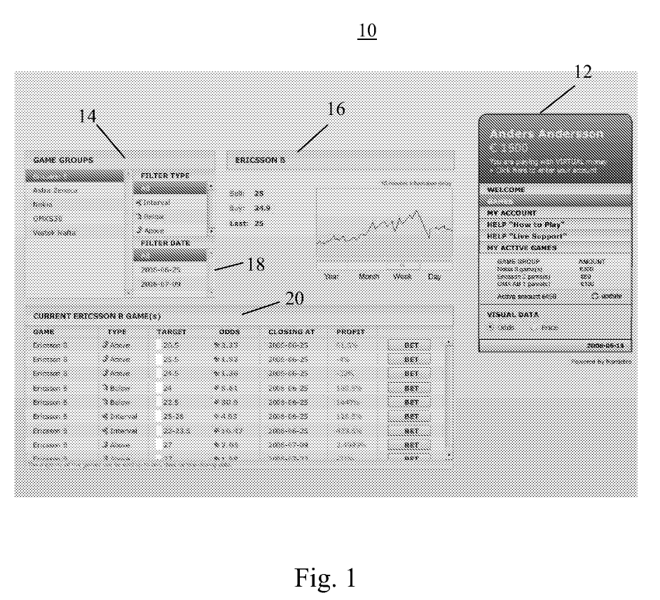

FIG. 1 illustrates one embodiment of an interface 10 utilized by an end user to trade financial instruments in accordance with the present invention. A possible interface 10 for an end user to trade on the stock/commodity market could be realized through an Internet home page. The interface thus showing an end user frame/window 12 for trading options and guidance as depicted in one possible embodiment of frame 12. A game/betting group frame 14, where a number of well known, mostly Swedish companies, are listed, whereby Ericsson AB is chosen for betting in this example by an end user.

In the depicted frames/windows of FIG. 1, all frames comprise scroll bars, or slide bars for selection of provided options.

Ericsson is a world-leading provider of telecommunications equipment and related services to mobile and fixed network operators globally.

As depicted in games status frame 16, the Ericsson share is currently quoted at sell 25 and buy 24.9 with last quote at 25. Thus, the end user is able to follow quotes for different discrete times through utilizing the functions in frame 14.

In this embodiment the filter type for possible betting in frame 14 has three options/types for trading above, interval, and below, as depicted in frame 14, the end user has chosen all options. Moreover, Frame 18 shows filter dates Jun. 25, 2006, Jul. 9, 2006 (Swedish type of dating, year-month-day) which are open for trading. The end user has chosen all days for trading.

In the depicted frame 20 in FIG. 1, the current Ericsson trading available for the mentioned days is listed. The frame 20 provides columns listing game group, filter type, target trading price on game closure day, odds calculated in accordance with the present invention, closing day of the various games, historical return of the games since yesterday, and a column of buttons for betting.

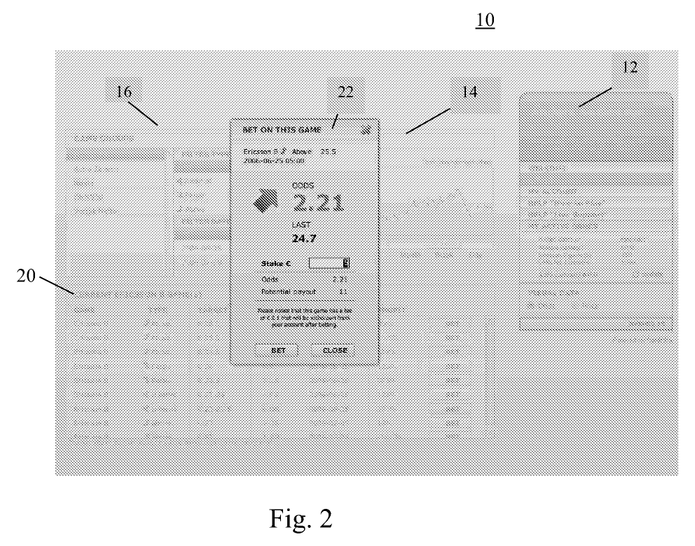

In FIG. 2 it is illustrated a further function in the interface of FIG. 1 in accordance with the present invention, depicted as a frame 22 for trading. In this example, the trading in frame 22 is of the type of betting on a Ericsson share pricing above 25.5 at Jun. 25, 2006. The end user has selected to bet [symbol] 5, at the odds of 2.21 that the Ericsson share is above 25.5 at the closure day Jun. 25, 2006. In order to make a trade, the end user now clicks the buy button. If the share pricing is above 25.5 on the closure day, the end user earns [symbol] 11 (2.21× [symbol] 5).

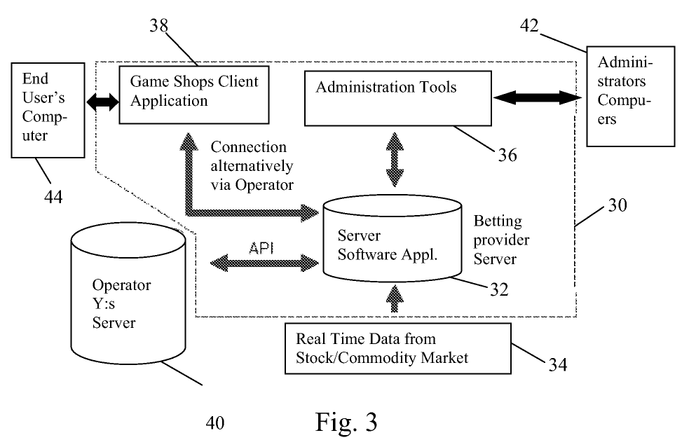

FIG. 3 schematically illustrates one embodiment of a system for trading in accordance with the present invention. The betting provider server system 30 is depicted through broken lines in FIG. 1, where the server software application 32 is provided. The software provides a generator in a network for at least one of data and telecommunication indicated by double arrows depicting communication paths. It is adapted to generate real time odds for scenarios of the pricing of financial instruments for a plurality of entities (shares, indexes) belonging to the instruments. Every entities odds is calculated theoretically from a real time pricing of an entity on the actual stock/commodity market 34, and subtracted by a predetermined margin based on a percentage constituting a final calculated odds.

The margin is applied to gratify the provider/administrator/operator 30,40, 42 running the system. It is anticipated that the provider acts as an administrator in one embodiment of the present invention.

To be able to administrate the system of the present invention it provides administrations tools, which are utilized by the provider 30 and through administration computers 42. In the embodiment of FIG. 3, the provider 30 is connected to a game shop clients application providing an end user 44 with an interface according to FIG. 1 and 2. Alternatively, the connection to the game shops client application can be provided through an operator Y's server 40.

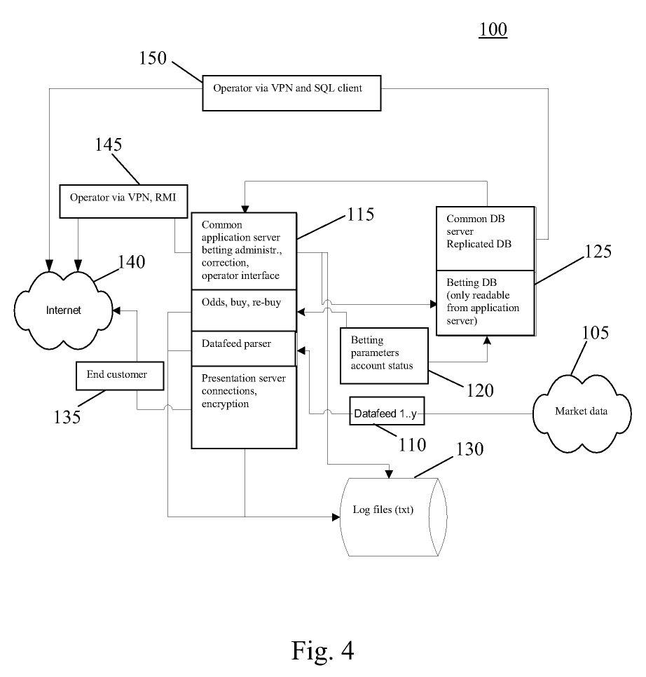

In FIG. 4 a more detailed embodiment of a system for trading in accordance with the present invention is illustrated. Hence, the system 100 applying the method of the present invention comprises market data/parameters from a stock/commodity market 105 through a data feed 105, feeding data 1 . . . y to a common application server 115. It is common to an operator 145,150 and a provider/administrator. The server 115 also including a presentation server, presenting an interface in accordance with FIG. 1 and 2 to an end customer/user 135. Odds, buys and re-buys/return trades are managed in the server 115, and important data from the server 115 is logged in log text files 130.

Moreover, betting parameters and account status are stored in a memory 120, accessible from the common server 115 and a common database and betting database 125. The betting database is only readable from the server 115. The common part of database 125 is shared between operators 145,150 and provider in the form of a replicated database.

Communication between provider, operators 145, 150, and end user 135 is preferably upheld through Internet 140. The data that is provided the log files 130 is also provided the betting database 125.

Operators are in two different embodiments 145, 150 communicating through a VPN (Virtual Private Network), or RMI (Remote Method and Invocation, Java) 145, or via VPN and a SQL client (SQL, Structured Query Language) 150.

While the present invention has been described in accordance with preferred compositions and embodiments, it is to be understood that certain substitutions and alterations may be made thereto without departing from the spirit and scope of the following claims.

We claim:

1. A method of adapting the original Black-Scholes option pricing model to determine real time calculated theoretical odds for scenarios of the pricing of financial instruments to create a virtual financial market where end users are able to make earnings relating to said calculated odds for a price of said instruments at a predetermined discrete time creating an odds model which automatically calculates price during the trading hours of an actual financial market, said odds reflecting the expectations of the actual financial market, comprising:
utilizing the Black-Scholes option pricing adapted to comprise the number of trading days until said predetermined discrete time including fractions of a day, divided by actual trading days of a trading year, taking into account an implied risk premium provided in the Black-Scholes option pricing model; and
paying said end users the amount betted on said financial instruments at a correct betting, times at least a fraction of said calculated odds, thus creating a virtual financial market.

2. A method according to claim 1, wherein said calculated odds being subtracted by a margin to form said fraction of said calculated odds.

3. A method according to claim 1, wherein said virtual financial market is utilized to educate end users of the trade rules and price fluctuations of pricings of said instruments in a financial market.

4. A method according to claim 1, wherein said implied risk premium provided in the Black-Scholes option pricing model is comprised in said model where conventionally a continuous yield is situated, but with reversed plus and minus signs, respectively.

5. A system adapted to the trade of bets on financial instruments on a financial market thus opening up a virtual market to make earnings related to the actual financial market pricings for said financial instruments, comprising:
a generator software in a server in a network for at least one of data and telecommunication, adapted to generate real time odds for scenarios of the pricing of financial instruments for a plurality of entities belonging to said instruments, every entities odds being calculated theoretically from a real time pricing of an entity on said actual financial market, and subtracted by a predetermined margin based on a percentage constituting a final calculated odds, said margin is set by at least one administrator running the system, said real time odds being based on financial market expectations according to a modified Black-Scholes option theory utilized for a financial market, said modified Black-Scholes model taking into account an implied risk premium provided in the Black-Scholes option pricing model; and
an interface in said network connecting end users to stake according to said final calculated odds to a determined pricing based on said modified Black-Scholes theory for at least one of said entities, said final odds being valid a predetermined discrete time for said pricing, whereby said end customer is paid said stake times said final calculated odds if said pricing is valid within a predetermined range of pricing at the lapse of said discrete time, said end user thus being provided to make bets based on a real financial market through said virtual financial market.

6. A system according to claim 5, wherein said financial instrument is a stock/commodity or an index.

7. A system according to claim 5, wherein said virtual financial market is utilized to educate end users of the trade rules and price fluctuations of pricings of said instruments in a financial market.

8. A system according to claim 5, wherein said implied risk premium provided in the Black-Scholes option pricing model is comprised in said model where conventionally a continuous yield is situated, but with reversed plus and minus signs, respectively.
